(19) United States
(12) Patent Application Publication
(10) Pub. No.: US 2011/0230802 A1
(43) Pub. Date: Sep. 22, 2011

(54) MASSAGE DEVICE WITH MAGNETIC FIELD EFFECT CONTROL CAPABILITIES

(75) Inventor: Simon Siu Man Nan, Ontario (CA)

(73) Assignee: NANMA MANUFACTURING CO., LTD., Chai Wan (CN)

(21) Appl. No.: 12/725,179

(22) Filed: Mar. 16, 2010

(51) Int. Cl. A61H 1/00

(52) U.S. Cl. 601/46

(57) ABSTRACT

A massage device having a hand-held unit including a first controller coaxially disposed within a second controller for controlling the operation of first and second massage actuators of the massage device is disclosed. The first controller includes a faceplate and the second controller includes a turning knob having the faceplate coaxially disposed therein. The second controller further includes a magnet carrier having a plurality of magnets with each magnet producing a respective magnetic field. The hand-held unit further includes a casing that defines a chamber with a framework removably disposed therein that is operatively coupled to the first and second controllers. The framework includes a push button that is operatively coupled to the faceplate, which is actuated by the first controller when the faceplate is depressed. The framework further includes first and second magnetic switches that may be triggered when the turning knob is rotated in one direction such that the magnetic field of one of the plurality of magnets triggers one of the first or second magnetic switches while rotating the turning knob in an opposite direction triggers the other one of the first or second magnetic switches to control the intensity of the first and second massage actuators.

### FIELD

This application relates to a massage device, and more particularly to a massage device with magnetic field effect control capabilities.

### BACKGROUND

Prior art massage devices having multiple massage actuators for application to the exterior and/or interior portions of the human body usually have different controllers for selecting the mode of massage actuation as well as adjusting the actuation intensities of each massage actuator during operation. In many cases, the controller for controlling the intensity of each massage actuator has a rotational control arrangement, such as a rotating knob, that either increases or decreases the actuation intensity of respective massage actuators depending on the direction that the turning knob is being rotated, while the other separately located controller is actuated to select the particular massage actuation for operation. However, it would be desirable to provide a controller for selecting the operational modes of operation that is coaxially disposed within a rotational type controller for adjusting the intensity of the massage actuators. It would also be desirable to have a massage device with an arrangement of coaxially disposed controllers that maintain the watertight integrity of the device.

### SUMMARY

In an embodiment, massage device may include a first massage actuator for providing a first massage function and a second massage actuator for providing a second massage function. The massage device further includes a hand-held unit for controlling the operation of the first massage actuator and the second massage actuator. The hand-held device defines a chamber with a framework removably disposed within the chamber for providing a power source with the framework including a means for controlling the operation of the first massage actuator and the second massage actuator. The framework includes a battery chamber for receiving a plurality of batteries for providing power to massage device. The hand-held unit may further include a first controller having a rotational control arrangement and a second controller having a push button control arrangement for controlling the operation of the first and second massage actuators. The first controller includes a turning knob that rotates to control the intensity of either the first or second massage actuators, and the second controller includes a faceplate coaxially disposed within the turning knob for selecting the operation of either the first or the second massage actuators.

In another embodiment, a massage device may include a plurality of massage actuators for providing a plurality of massage effects. One of the plurality of massage actuators is coupled to a gear assembly encased in a gear assembly housing for driving the one of the plurality of massage actuators. The massage device further includes a hand-held unit including a casing engaged to the gear assembly housing. The casing defines a chamber in communication with a proximal opening with a framework disposed inside the chamber. The framework includes a plurality of magnetic switches and a push button and the hand-held unit further includes a first controller and a second controller for controlling the operation of the plurality of massage actuators. The first controller has a turning knob and the second controller has a faceplate coaxially disposed within the turning knob, wherein the turning knob is coupled to a magnet carrier having a plurality of magnets with each of the plurality of magnets generating a respective magnetic field. Rotation of the turning knob in one direction causes rotation of the magnet carrier in the same direction which triggers the plurality of magnetic switches in one sequence, while rotation of the turning knob in the opposite direction causes rotation of the magnet carrier in the same opposite direction which triggers the plurality of magnetic switches in a reverse sequence such that the intensity of the plurality of massage actuators may be controlled by rotation of the turning knob.

In yet another embodiment, a massage device may include one or more massage actuators for providing one or more massage effects and a hand-held unit coupled to the one or more massage actuators. The hand-held unit includes a casing defining a chamber having a framework disposed therein with the framework having a push button for actuating the one or more massage actuators coupled to the hand-held unit and a plurality of magnetic switches for controlling the function of the one or more massage actuators. The casing includes a first controller having a second controller coaxially disposed within the first controller. The second controller includes a faceplate for actuating the push button on the framework and the first controller includes a turning knob coupled to a magnet carrier having a plurality of magnets with each of the plurality of magnets generating a respective magnetic field. Rotation of the turning knob in one direction concurrently rotates the magnet carrier in the same direction such that the plurality of magnetic switches is triggered in one sequence by a respective magnetic field generated by at least one of the plurality of magnets of the magnet carrier, while rotation of the turning knob in the opposite direction concurrently rotates the magnet carrier in the same opposite direction such that the plurality of magnetic switches is triggered in a reverse sequence by a respective magnetic field produced by at least one of the plurality of magnets.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is an elevated perspective view of the massage device showing a sleeve in phantom;

FIG. 2 is a partially exploded perspective view of the massage device;

FIG. 3A is an exploded view of the hand-held unit and massage actuator for the massage device;

FIG. 3B is an exploded view of the framework and battery cover for the massage device; and

FIG. 4 is an enlarged partial cross-sectional view of the hand-held unit of the massage device illustrating the co-axial arrangement of the first and second controllers.

Corresponding reference characters indicate corresponding elements among the view of the drawings. The headings used in the figures should not be interpreted to limit the scope of the claims.

### DETAILED DESCRIPTION

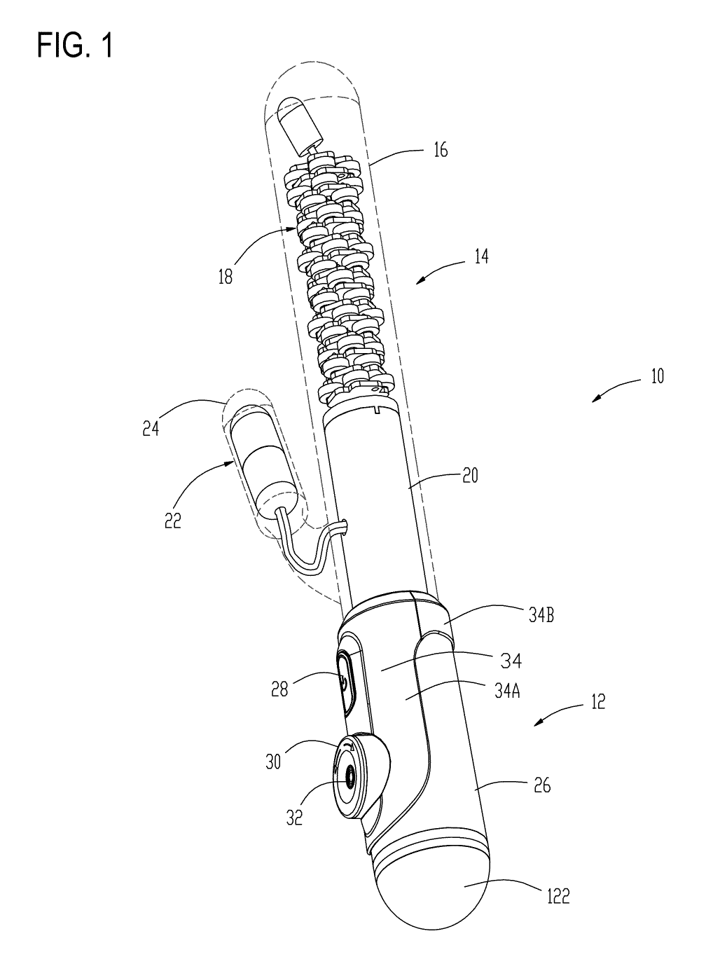

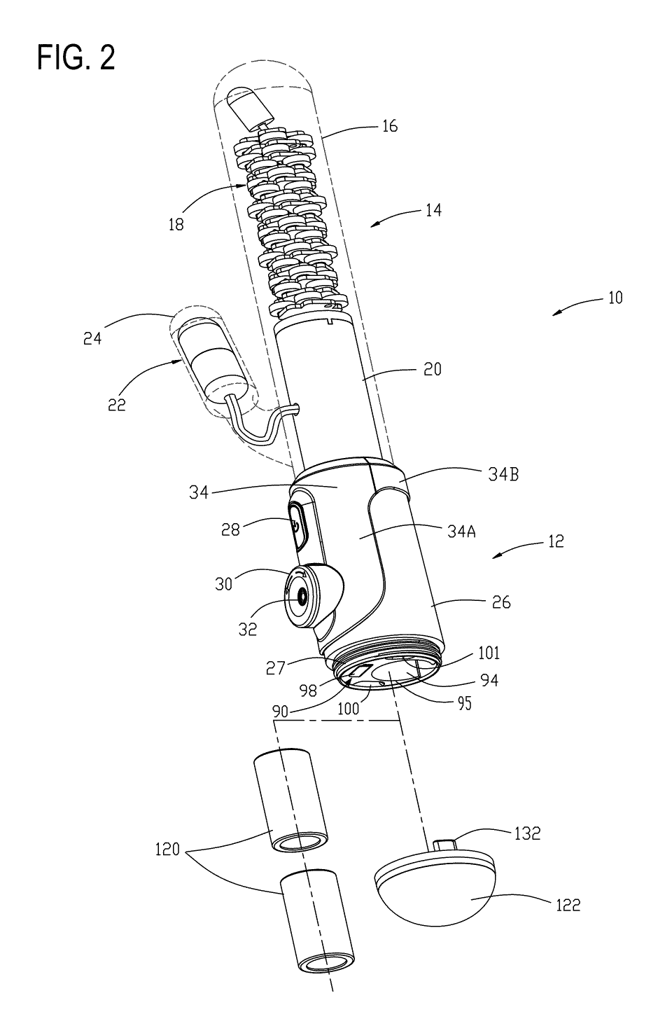

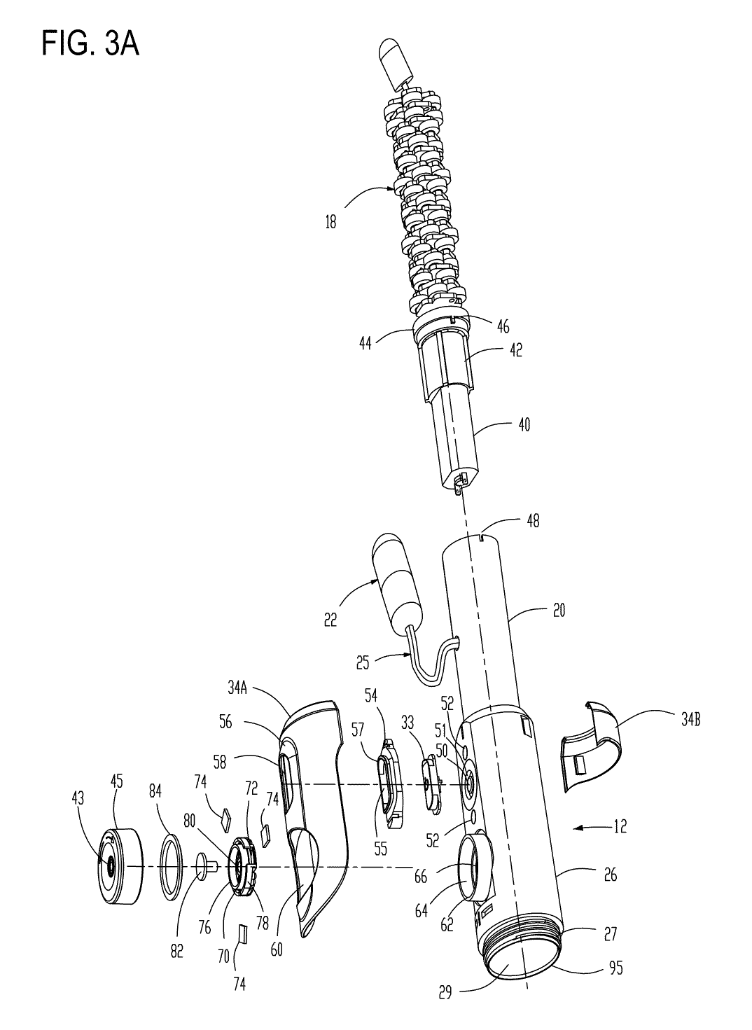

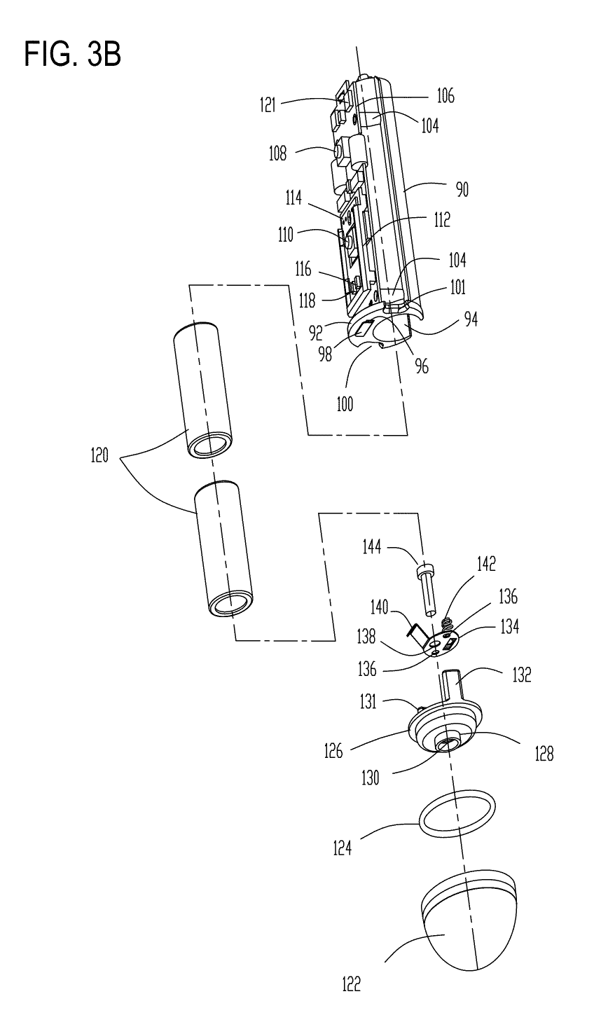

Referring to the drawings, embodiments of the massage device are illustrated and generally indicated as 10 in FIG. 1. Referring to FIGS. 1 and 2, the massage device 10 in one embodiment has a hand-held unit 12 that includes a power source, such as a plurality of batteries 120, for providing electrical power to operate the massage device 10 and a multiple controller arrangement for controlling the operation of the massage device 10 as shall be discussed in greater detail below. In one embodiment, the massage device 10 may include a first massage actuator 14, such as a squirming actuator assembly 18 that imparts a gyrating, squirming action and a second massage actuator 22, such as a vibratory component that imparts vibratory pulses at various intensities and pulse patterns. As shown in FIG. 3A, the squirming actuator assembly 18 is driven by an arrangement of a gear assembly 42 and electric motor 40 which is encased inside a gear assembly housing 20 engaged to the hand-held unit 12.

The hand-held unit 12 may be engaged to a main sleeve 16 that encases the first massage actuator 14. The main sleeve 16 may be made of a resilient material adapted to impart the gyrating, squirming action generated by the squirming actuator assembly 18. In one embodiment, the main sleeve 16 may also define a secondary sleeve 24 that encases the second massage actuator 22 and is made of the same resilient material as the main sleeve 16 in order to impart the vibratory pulses generated by the second massage actuator 22 to the user through the secondary sleeve 24. In various embodiments, the secondary sleeve 24 may be integral or attached to the main sleeve 16 or could be altogether absent from the main sleeve 16.

The hand-held unit 12 may further include a casing 26 engaged to an apron 34 that includes a front cover 34A coupled to a rear cover 34B. The front cover 34A accommodates a power switch 28 that turns the electrical power ON or OFF to the massage device 10, a rotational type first controller 30 for adjusting the intensity of the first massage actuator 14 and the second massage actuator 22, and a push button type second controller 32 for actuating either the first or second massage actuators 14 and 22. In one embodiment, the front cover 34A may be bonded to the rear cover 34B using an adhesive or coupled together using a mechanical means of attachment.

Referring to FIGS. 1, 2, 3A and 3B, a battery cover 122 is detachably coupled to the proximal end of the casing 26 for encasing the plurality of batteries 120 (FIG. 2) inside the hand-held unit 12 to provide a source of electrical power to the massage device 10. The battery cover 122 may define internal threads (not shown) for coupling with external threads 27 defined along the proximal end portion of the hand-held unit 12 when engaging the battery cover 122 to the hand-held unit 12. The proximal end portion of the hand-held unit 12 further includes an opening 95 in communication with a chamber 29 for receiving a framework 90 therein that encases the plurality of batteries 122.

Referring specifically to FIG. 3B, the framework 90 may define a battery chamber 94 adapted to receive the plurality of batteries 120 therein for providing a power source. A pair of notches 100 and 101 are defined proximate the battery chamber 94 and are sized and shaped to engage a pair of pegs 131 and 132 defined by a pole plate holder 126 that is seated within the battery cover 122. The pegs 131 and 132 are engaged to respective notches 100 and 101 prior to the battery cover 122 being brought into engagement with external threads 27 of the hand-held unit 12. The engagement of the pegs 131 and 132 with the respective notches 100 and 101 of the framework 90 will prevent a pole plate 134, which is fixed on the pole plate holder 126, from rotating relative to the batteries 120. As used herein, the term “proximal” shall mean that end or portion of the massage device 10 that is closest to the battery cover 122, while the term “distal” shall mean that end or portion of the massage device 10 that is farthest from the battery cover 122.

Referring back to FIG. 3A, in one embodiment the squirming actuator assembly 18 is fixedly attached to the output shaft (not shown) of the gearbox assembly 42 and driven by the electric motor 40. The squirming actuator assembly 18 may include a cap 44 having an extrusion 46 defined along the circumference thereof that is engaged between the gearbox assembly 42 and the squirming actuator assembly 18. During assembly of the massage device 10, the gearbox assembly 42 and electric motor 40 are disposed inside the gear assembly housing 20 with the extrusion 46 of cap 44 engaged to a notch 48 defined along the distal end portion of the gear assembly housing 20 to encase the gearbox assembly 42 and electric motor 40 inside gear assembly housing 20.

In one embodiment, the second massage actuator 22 may be a pulsating massage actuator that generates vibratory pulses when made operational. A pair of electric cables 25 may electrically couple the second massage actuator 22 to the power source of the framework 90.

As further shown, the power switch 28 may include a membrane 50 made from a resilient material that seals an aperture 51 defined by casing 26. A push button component 33 that forms a part of the power switch 28 is engaged to the membrane 50 that permits the push button component 33 to actuate a pushpin 82 for operating the power switch 28 as shall be discussed below. A pair of windows 52 may be defined on either side of membrane 50 along casing 26 for providing a viewing site for light indicators. The casing 26 may also define a circular boss 62 that includes a chamber 64 having a membrane 66 made of a resilient material positioned at the bottom of chamber 64 that seals another aperture (not shown) defined by casing 26 to provide a location for the first and second controllers 30 and 32. During the manufacturing process, the push button component 28 is engaged to the top portion of membrane 50 and disposed within an aperture 55 defined by a circular boss 57 of a light-pipe 54, which is positioned on the casing 26 on top of the pair of transparent windows 52. The light-pipe 55 provides a viewing lens for permitting light, such as light from one or more light emitting diodes 121 (FIG. 3B), to be viewed through transparent windows 52.

The front cover 34A includes a boss portion 56 defining a slot 58 with the boss portion 56 in communication with a round hole 60 defined through the front cover 34A. When the front cover 34A is bonded or otherwise engaged to the casing 26, the slot 58 provides a space that accommodates the circular boss 57 of light-pipe 55, while the round hole 60 provides a space that accommodates circular boss 62 defined along casing 26.

Referring to FIG. 3B, the framework 90 is disposed inside the chamber 29 of casing 26 and includes a main printed circuit board 106 that includes the plurality of light emitting diodes 121, which transmit the light through the respective transparent windows 52 via light-pipe 54 such that the emitted light can be viewed at the circular boss 57 mounted inside front cover 34A.

In one embodiment, the first controller 30 may have a magnetic field effect control capability for controlling the intensity of the first and second massage actuators 14 and 22. The first controller 30 may include a rotatable magnet carrier 70 that provides a means for controlling the intensity of the massage effects generated by the first and second massage actuators 14 and 22 using a magnetic field effect control arrangement.

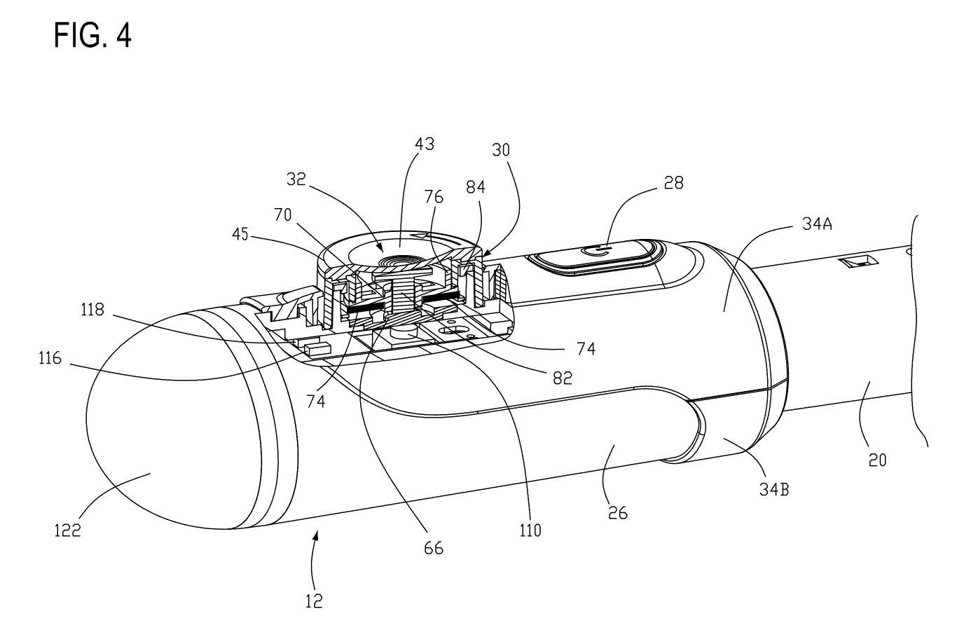

Referring to FIGS. 3A and 4, the round hole 60 of front cover 34A may accommodate the magnet carrier 70. The magnet carrier 70 defines a plurality of pockets 72 evenly spaced along the circumference of the magnet carrier 70 with each of the plurality of pockets 72 being sized and shaped to receive a respective magnet 74. The magnet carrier 70 also defines a circular boss 76 that includes a chamber for accommodating the head of the pushpin 82 of the second controller 32. The pushpin 82 is inserted through a center hole 80 defined by the circular boss 76 at the bottom of the chamber of the magnet carrier 70. In addition, the magnet carrier 70 defines a plurality of circular segments 78 evenly spaced around the circumference of the circular boss 76.

During assembly of the massage device 10, the magnet carrier 70 along with the plurality of magnets 74 and the pushpin 82 are disposed within the chamber 64 of the circular boss 64 defined by casing 26 of the hand-held unit 12. This structural arrangement allows the push button-type second controller 32 to be co-axially disposed within the rotational-type first controller 30. As used herein, the term “co-axially disposed” shall mean that the first controller 30 and second controller 32 have coincident axes. A retainer ring 84 may be bonded on the edge of the circular boss 62 to retain the magnet carrier 70 within the chamber 64 and prevent the magnet carrier 70 from being dislodged from the circular boss 62. The circular boss 76 of the magnet carrier 70 is sized and shaped to accommodate a turning knob 45 for allowing the magnet carrier 70 to be rotated. A faceplate 43 is coaxially disposed and coupled within the turning knob 45. In one embodiment, the faceplate may be made of a resilient material. In operation, the faceplate 43 is depressed in order to actuate the second controller 32 and select either the first or second massage actuators 14 or 22 for operation, while the turning knob 45 is rotated to adjust the intensity of either the first or second massage actuators 14 or 22. In one embodiment, turning knob 45 may define a circular internal rib (not shown), which can be inserted into a space defined by the circular boss 76 and each of the plurality of circular segments 78 of the magnet carrier 70. As such, rotation of the turning knob 45 will cause the magnet carrier 70 to rotate in the same direction.

As shown in FIG. 3B, the framework 90 may define a semi-circular flange portion 92 at the proximal end thereof defined adjacent the battery compartment 94 with a slot 96 defined to accommodate a metal plate 98 to be inserted through the slot 96 during assembly. The metal plate 98 is connected to the main printed circuit board 106 for establishing a conductive pathway for supplying electrical power from the batteries 120 to the circuit board 106 and other electrical components of the massage device 10. In addition, the framework 90 may include a plurality of mounting posts 104 for mounting the main printed circuit board 106 using screws (not shown), while the pair of notches 100 and 101 are engaged to the pegs 131 and 132 for engaging pole plate holder 126 to the framework 90.

The main printed circuit board 106 of framework 90 includes a push button 108 that is a part of the power switch 28 and is actuated in order to turn the electrical power ON or OFF to the massage device 10. In addition, the main printed circuit board 106 may include a push button 110 that forms a part of the second controller 32 for selecting the massage actuation modes that actuate the first or second massage actuators 14 and 22.

The framework 90 may further include a frame 112 adapted to engage an auxiliary printed circuit board 114, which is mounted on the main printed circuit board 106. The auxiliary printed circuit board 114 includes a pair of magnetic switches 116 and 118 that form a part of the first controller 30 as shall be discussed in greater detail below.

During assembly of the massage device 10, the framework 90 with the main and auxiliary printed circuit boards 106 and 114 mounted thereon are inserted into the chamber 29 of the hand-held unit 12 such that the push buttons 108 and 110 are respectively positioned and aligned under resilient membranes 50 and 66, respectively. In this orientation, pressing the power switch 28 causes the push button 108 to be actuated through membrane 50, while pressing the faceplate 43 causes the push button 110 to be actuated through membrane 66.

To maintain the watertight integrity of the massage device 10, a sealing element 124, such as an O-ring, made from a resilient material may be disposed inside the battery cover 122.

In one embodiment, the sealing element 124 is retained in position by the pole plate holder 126. The pole plate holder 126 includes a circular boss 128 that surrounds a center hole 130 defined at the proximal end of pole plate holder 126, while pegs 131 and 132 extend axially from the distal end of the pole plate holder 126. In addition, the distal end face of the pole plate holder 126 includes a pair of posts (not shown), which are sized and shaped to engage respective pair of holes 136 defined by a pole plate 134 when the pole plate 134 is engaged to the pole plate holder 126.

In one embodiment, the pole plate 134 includes an off-center hole 138, a conductive contact arm 140 that extends outwardly from the pole plate 134, and an integrated metal spring 142 engaged through a hole 136 defined by the pole plate 134. During assembly, the pole plate 134, which may be integral with or coupled to the pole plate holder 126, is positioned inside a cavity (not shown) defined by the battery cover 122 by anchoring the proximal end of pin 144 through the off-center hole 138 to the battery cover 122 such that the pole plate holder 126 and the pole plate 134 are retained inside the battery cover 144. This structural arrangement of the pole plate holder 126 and the pole plate 134 cause both the pole plate holder 126 and pole plate 134 to rotate about the longitudinal axis of the battery cover 122 as illustrated in FIG. 3B.

Referring to FIG. 4, the structure and operation of the first controller 30 and second controller 32 are illustrated. In one embodiment, rotating the turn knob 45 of the first controller 30 in a clockwise direction causes the magnet carrier 70 and the plurality of magnets 74 to be concurrently rotated in the same clockwise direction. During the clockwise rotation of the magnet carrier 70, one of the magnets 74 will approach the magnetic switches 116 and 118 in sequence. In one embodiment, the approach of one of the magnets 74 as the magnet carrier 70 is rotated will cause the magnetic field generated by that particular magnet 74 to first trigger the magnetic switch 116 and then later trigger the magnetic switch 118. This triggering the magnetic switches 116 and 118 in sequence causes the main printed circuit board 106 to increase the actuation intensity of either the first or second massage actuators 14 and 22, depending on which actuator has been selected using the second controller 32. However, rotating the turn knob 43 in the opposite, or counter-clockwise direction, will cause the magnet carrier 70 and the plurality of magnets 74 to be rotated in the same counter-clockwise direction, which will cause another one of the magnets 74 to approach the arrangement of magnetic switches 116 and 118 in an opposite sequence. As one of the magnets 74 comes into proximity with the magnetic switch 118, the magnetic field generated by that magnet 74 first triggers the magnetic switch 118 and then later triggers magnetic switch 116 such that the main printed circuit board 106 will reduce the actuation intensity of either the first or second massage actuators 14 and 22. In this manner, rotation of the turning knob 45 allows the magnetic field control capability of the first controller 30 to control the intensity of the massage actuator 14 and 22, while also permitting the second controller 32 to be co-axially disposed within the first controller 30 which allows selection of operation modes by the user.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A massage device comprising:
a first massage actuator for providing a first massage function;
a second massage actuator for providing a second massage function; and
a hand-held unit for controlling the operation of the first massage actuator and the second massage actuator, the hand-held device defining a chamber with a framework removably disposed within the chamber for providing a power source, the framework including a means for controlling the operation of the first massage actuator and the second massage actuator, the framework including a battery chamber for receiving a plurality of batteries for providing power to massage device, the hand-held unit including a first controller having a rotational control arrangement and a second controller having a push button control arrangement for controlling the operation of the first and second massage actuators, the first controller including a turning knob that rotates to control the intensity of either the first or second massage actuators, and the second controller including a faceplate coaxially disposed within the turning knob for selecting the operation of either the first or the second massage actuators.

2. The massage device of claim 1, further comprising a gear assembly housing with a gear assembly coupled to the first massage actuator for driving the first massage actuator.

3. The massage device of claim 1, wherein the framework further includes first and second magnetic switches that are actuated in sequence by rotation of the turning knob of the first controller and a push button that is actuated by depressing the faceplate of the second controller.

4. The massage device of claim 3, wherein the first controller comprises a magnet carrier coupled to the turn knob such that rotating the turning knob concurrently rotates the magnet carrier, the magnet carrier including a plurality of magnets, wherein each of the plurality of magnets produces a respective magnetic field.

5. The massage device of claim 4, wherein rotation of the turning knob in one direction causes the plurality of magnets in the magnet carrier to rotate in the same direction for controlling the intensity of the first massage actuator or second massage actuator.

6. The massage device of claim 4, wherein rotation of the turning knob causes the magnetic field of at least one of the plurality of magnets of the magnet carrier to trigger the first and second magnetic switches in one sequence, while rotation of the turning knob in the opposite direction causes the magnetic field of at least one of the plurality of magnets to trigger the first and second magnetic switches in a reverse sequence, wherein triggering the first and second magnetic switches in one sequence when turning the turning knob in one direction reduces the intensity of actuation of either the first massage actuator or the second massage actuator, while triggering of the first and second magnetic switches in the reverse sequence when turning the turning knob in the opposite direction increases the intensity of actuation of either the first massage actuator or second massage actuator.

7. The massage device of claim 4, wherein the magnet carrier further defines a plurality of pockets equidistantly spaced around the magnet carrier with each of the plurality of pockets having a respective one of the plurality of magnets disposed therein.

8. The massage device of claim 4, further comprising a pushpin axially disposed within the magnet carrier, the pushpin having one end engaged to the faceplate and an opposing end engaged to the push button of the framework such that the push button is actuated by the pushpin when the faceplate is depressed.

9. The massage device of claim 1, wherein actuation of the push button by the faceplate actuates either the first massage actuator or the second massage actuator for operation.

10. The massage device of claim 2, wherein the first massage actuator is a squirming actuator that provides a gyrating, squirming massage action, the squirming actuator being driven by an electric motor through the gear assembly and the second massage actuator is a vibratory component that provides a vibratory effect.

11. The massage device of claim 8, further comprising a resilient membrane engaged between the opposing end of the pushpin and the push button of the framework.

12. The massage device of claim 1, the hand-held unit further comprising a casing with an apron engaged to the casing, the apron including a face cover coupled to a rear cover for accommodating.

13. The massage device of claim 1, further comprising a resilient sleeve engaged to the hand-held unit, wherein the resilient sleeve is sized and shaped to encase the first massage actuator and the second massage actuator.

14. The massage device of claim 1, wherein the casing of the hand-held unit defines external threads adapted to engage a battery cover with a sealing element disposed within the battery cover for establishing a fluid tight seal between the casing and the battery cover when the battery cover is engaged to the casing.

15. The massage device of claim 13, wherein the sealing element is an O-ring.

16. A massage device comprising:
a plurality of massage actuators for providing a plurality of massage effects, one of the plurality of massage actuators being coupled to a gear assembly encased in a gear assembly housing for driving the one of the plurality of massage actuators; and
a hand-held unit including a casing engaged to the gear assembly housing, the casing defining a chamber in communication with a proximal opening with a framework disposed inside the chamber, the framework including a plurality of magnetic switches and a push button, the hand-held unit further including a first controller and a second controller for controlling the operation of the plurality of massage actuators, the first controller having a turning knob and the second controller having an faceplate coaxially disposed within the turning knob, wherein the turning knob is coupled to a magnet carrier having a plurality of magnets with each of the plurality of magnets generating a respective magnetic field, wherein rotation of the turning knob in one direction causes rotation of the magnet carrier in the same direction which triggers the plurality of magnetic switches in one sequence, while rotation of the turning knob in the opposite direction causes rotation of the magnet carrier in the same opposite direction which triggers the plurality of magnetic switches in a reverse sequence such that the intensity of the plurality of massage actuators may be controlled by rotation of the turning knob.

17. The massage device of claim 16, further comprising a pushpin axially disposed within the magnet carrier, the pushpin having one end engaged to the faceplate and an opposing end engaged to the push button of the framework such that the push button is actuated by the pushpin when the faceplate is depressed.

18. The massage device of claim 16, wherein the magnet carrier further defines a plurality of pockets equidistantly spaced around the magnet carrier with each of the plurality of pockets having a respective one of the plurality of magnets disposed therein.

19. A massage device comprising:
one or more massage actuators for providing one or more massage effects; and
a hand-held unit coupled to the one or more massage actuators, the hand-held unit including a casing defining a chamber having a framework disposed therein, the framework having a push button for actuating the one or more massage actuators coupled to the hand-held unit and a plurality of magnetic switches for controlling the function of the one or more massage actuators, the casing including a first controller having a second controller coaxially disposed within the first controller, the second controller including a faceplate for actuating the push button on the framework and the first controller including a turning knob coupled to a magnet carrier having a plurality of magnets with each of the plurality of magnets generating a respective magnetic field, wherein rotation of the turning knob in one direction concurrently rotates the magnet carrier in the same direction such that the plurality of magnetic switches is triggered in one sequence by a respective magnetic field generated by at least one of the plurality of magnets of the magnet carrier, while rotation of the turning knob in the opposite direction concurrently rotates the magnet carrier in the same opposite direction such that the plurality of magnetic switches is triggered in a reverse sequence by a respective magnetic field produced by at least one of the plurality of magnets.

20. The massage device of claim 19, further comprising a pushpin axially disposed within the magnet carrier, the pushpin having one end engaged to the faceplate and an opposing end engaged to the push button of the framework such that the push button is actuated by the pushpin when the faceplate is depressed.
